(19) United States
(12) Patent Application Publication
(10) Pub. No.: US 2024/0002226 A1
(43) Pub. Date: Jan. 4, 2024

(54) CARBON-FREE DIHYDROGEN PRODUCTION AND DELIVERY UNIT; METHOD FOR OPERATING SAID UNIT

(71) Applicant: SAKOWIN, Frejus (FR)

(72) Inventors: Gerard GATT, Frejus (FR); Yves GEORGE, Frejus (FR); Giovanni TRIMBOLI, Frejus (FR); Marilena RADOIU, Frejus (FR)

(73) Assignee: SAKOWIN, Frejus (FR)

(21) Appl. No.: 18/251,917

(22) PCT Filed: Nov. 3, 2021
(86) PCT No.: PCT/FR2021/051923

§ 371 Date: May 5, 2023

(30) Foreign Application Priority Data
Nov. 9, 2020 (FR) 20 11480

(51) Int. Cl. C01B 3/24; C01B 3/50; C01B 32/05; H01M 8/0612; B01J 19/08

(52) U.S. Cl. CPC C01B 3/24; C01B 3/50; C01B 32/05; H01M 8/0631; B01J 19/088; C01B 2203/0861; C01B 2203/1241; C01B 2203/04; B01J 2219/0869

(57) ABSTRACT

A dihydrogen production and delivery unit for a dihydrogen consumer, may include at least one gaseous hydrocarbon supply device, at least one microwave plasma plasmalysis reactor configured to generate, at a pressure equal to atmospheric pressure +/−15%, plasmalysis of the gaseous hydrocarbon supplied by the supply device and which produces, by carbon-free production, at least dihydrogen and solid carbon, the production and delivery unit comprising at least one storage device for the produced dihydrogen and at least one device for delivering to the consumer the dihydrogen stored in the storage device.

The present invention relates to the field of dihydrogen production and delivery. More particularly, the present invention relates to a unit for the production and delivery of dihydrogen in a carbon-free manner, that is to say using means and processes that almost completely eliminate the generation of carbon dioxide.

Dihydrogen is considered to be a future energy vector with multiple applications such as transport or industrial production. Thus, the extensive use dihydrogen as fuel for cars and other transportation means is envisaged.

The production of large amounts of dihydrogen is mainly based on two different methods. A first method uses steam reforming, which consists in reacting a hydrocarbon, mainly methane, with water. The formation of dihydrogen is accompanied by a release of carbon dioxide which is one of the main greenhouse gases. When this solution is coupled with a carbon capture mechanism, only 70% to 90% of the carbon dioxide thus given off is sequestered so as not to be released into the atmosphere. Lastly, the conversion energy efficiency is limited to 82%, in particular due to the fact that steam reforming requires energy to be supplied. This efficiency is made even worse by the implementation of the carbon capture mechanism.

A second method uses electrolysis of water, which consists in splitting the water into dioxygen and dihydrogen by means of an electric current. The electric current is supplied by an external energy source which is, at present, mainly carbon-emitting, that is it produces carbon dioxide in particular. The electrolysis of water, which is a main method for producing dihydrogen along with the steam reforming of hydrocarbons, uses more electricity than the dihydrogen produces during its use, for example in a fuel cell.

The dihydrogen produced is generally transported, for example by truck, from the production unit to the site of delivery or consumption. However, the logistics for transportation are complex and expensive to implement.

Alternatively, the production site may also be the site of delivery or consumption. In this case, the choice of dihydrogen production technology is limited practically to just electrolysis, which requires investment and production costs, related to production capacity, that are even higher than for transporting dihydrogen.

Consequently, dihydrogen as a fuel remains very expensive and service station implementation costs remain too high to expand its use as an energy vector, based on known technologies.

One object of the present invention is to overcome at least one of the aforementioned drawbacks and also to bring about other advantages by providing a novel type of dihydrogen production and delivery unit.

The present invention proposes a dihydrogen production and delivery unit for a dihydrogen consumer, comprising at least one gaseous hydrocarbon supply device, at least one microwave plasma plasmalysis reactor which is configured to generate, at a pressure equal to atmospheric pressure +/−15%, plasmalysis of the gaseous hydrocarbon supplied by the supply device and which produces at least dihydrogen, the production and delivery unit comprising at least one storage device for the produced dihydrogen and at least one device for delivering to the consumer the dihydrogen stored in the storage device.

The production and delivery unit is configured to implement plasmalysis of the gaseous hydrocarbon which is a decomposition reaction of the gaseous hydrocarbon that gives rise to dihydrogen gas (H2_{(g)}) and solid carbon (C₍ₛ₎) by virtue of a plasma generated by microwave radiation.

One advantage of the invention is that it is environmentally friendly through the implementation gaseous hydrocarbon plasmalysis. The production and delivery unit makes it possible to produce dihydrogen in an almost entirely carbon-free manner, i.e. without emitting carbon dioxide, contrary to the other dihydrogen production technologies, such as steam reforming, which release carbon dioxide and can only capture 70% to 90% of the carbon dioxide emitted.

According to one advantage of the invention, the plasmalysis is carried out at atmospheric pressure, at +/15%. This reduces the technical means required for the reaction, which contributes to decarbonizing the production and delivery unit that is the subject of the invention.

An additional advantage of the invention lies in its ease of implementation on confined industrial sites or in small areas, in particular because there is no need to filter or store large quantities of carbon dioxide.

An additional advantage of the invention lies in low investment and running costs, with equipment service lives similar to other technologies, thereby allowing easy adoption by consumers.

An additional advantage of the invention lies in that it reduces the cost of producing dihydrogen by consuming much less electricity than the other known technologies. The production and delivery unit is thus designed to be economical in terms of resources and it is operated according to a method that almost completely eliminates the generation of carbon dioxide. It in this way that the production and delivery unit is carbon-free.

According to one embodiment, the gaseous hydrocarbon is selected from the group comprising methane, propane, butane and its isomers, natural gas, biomethane, and mixtures thereof. Natural gas may predominantly comprise methane CH₄ and, to a lesser extent, propane C₃H₈, butane C₄H₁₀ and its isomers.

According to one embodiment, the transport means is a terrestrial transport means, a sea transport means and/or an air transport means. Thus, a land transport means such as a truck or a car may easily be refueled. The same applies for a sea transport means such as a boat, or an air transport means such as an airplane.

According to one embodiment, the gaseous hydrocarbon supply device is a gaseous hydrocarbon transmission network and/or at least one storage tank constituting the production and delivery unit. The transmission network allows the gaseous hydrocarbon to be transported from the gas terminals. The transmission network is thus a gas pipeline for example. The storage tank may be supplied by tanker trucks or be replaced when it is empty.

According to an embodiment, the plasmalysis reactor comprises at least one resonant microwave radiation cavity that is configured to hold the plasma. A resonant microwave radiation cavity, also called a resonator, is a hollow space inside a metal block in which the microwave radiation resonates. The resonant microwave radiation cavity allows very effective coupling of the microwave radiation with the gaseous hydrocarbon so as to form the plasma.

Associating the resonant microwave radiation cavity with the device for storing the produced dihydrogen and the device for delivering the dihydrogen stored in the storage device to the consumer ensures stable dihydrogen production and storage while at the same time delivering this dihydrogen to the consumer where they are located as required without imposing complicated distribution logistics.

It is also advantageous for the delivery device to be in series with the storage device, so that the demand for dihydrogen does not affect the production of dihydrogen via the resonant microwave radiation cavity.

What should be understood here and hereinafter by “resonance” is that 100% of the microwave radiation is reflected across the microwave radiation cavity by at least one wall of the block that defines the microwave radiation cavity with respect to the microwave radiation generator when there is no plasma present in the microwave radiation cavity.

According to one embodiment, the pressure within at least part of the production and delivery unit, in particular within the microwave radiation cavity, is greater than or equal to atmospheric pressure.

According to one embodiment, the plasmalysis reactor comprises at least one microwave radiation generator, a transmission guide which is configured to guide the microwave radiation from the microwave radiation generator to the microwave radiation cavity, and a microwave radiation isolator which is configured to prevent any microwave radiation not absorbed by the plasma from returning to the microwave radiation generator.

According to one embodiment, the microwave radiation isolator is arranged between the microwave radiation generator and the transmission guide.

According to one embodiment, the microwave radiation generator is configured to deliver microwave radiation at a power of between 1 kW and 100 kW and a frequency of between 850 MHz and 6 GHz, preferentially equal to 896 MHz, 915 MHz, 922 MHz, 2.45 GHz or 5.8 GHz.

According to one embodiment, the microwave radiation generator is a magnetron microwave radiation generator or a semiconductor microwave generator, which is also called a solid-state microwave generator.

According to one embodiment, the transmission guide is a waveguide of rectangular or cylindrical cross section, or a coaxial cable.

According to one embodiment, the plasmalysis reactor comprises a cooling device that is configured to cool the microwave radiation generator with water and/or air.

According to one embodiment, the plasmalysis reactor comprises a plasma ignition device which comprises a retractable metal tip that is configured to be inserted into or retracted from the microwave radiation cavity using an actuator. In other words, the ignition device is an electromechanical mechanism equipped with an actuator that is configured to move a metal tip between a position outside the microwave radiation cavity, that is a retracted position, and a position inside the microwave radiation cavity. In the position inside the microwave radiation cavity, the metal tip is configured to generate an electric discharge which ignites the plasma required for plasmalysis.

According to one embodiment, the plasmalysis reactor comprises a gas injection device which has at least one nozzle that is configured to generate a gas flow of gaseous hydrocarbon from the supply system and is arranged in the microwave radiation cavity so as to form a vortex from the flow of gaseous hydrocarbon in the microwave radiation cavity.

According to one embodiment, the plasmalysis reactor is configured so that the gaseous hydrocarbon is a plasmagene gas and reacts to the plasmalysis to form dihydrogen and solid carbon.

According to one embodiment, the plasmalysis reactor comprises at least one nozzle tube which is configured to contain the plasma and ensure a gradual lowering of the temperature of the products from the plasmalysis to the outlet of the microwave radiation cavity.

According to one embodiment, the nozzle tube is composed at least partly of ceramic and/or metal. Thus, the nozzle tube is able to withstand the temperatures brought about by the plasma.

According to one embodiment, the plasmalysis reactor comprises at least one pipe arranged around the nozzle tube such that at least one portion of the pipe defines a chamber for thermally isolating the plasma. In other words, the pipe takes the shape of a concentric cylinder arranged around a portion of the nozzle tube, and the chamber is the space between the nozzle tube and the pipe. Thus, the chamber allows the plasma to be thermally isolated.

According to one embodiment, another part of the pipe defines a chamber for cooling the dihydrogen and solid carbon produced by the plasmalysis. Thus, the pipe allows the reaction products to be cooled. Solidification of the carbon is improved.

The reaction products group together the products from the plasmalysis and any leftover gaseous hydrocarbons that did not decompose during the plasmalysis.

According to one embodiment, the pipe comprises, on an inner face, a plurality of fins which extend radially from the inner face of the pipe in the direction of the nozzle tube and are thermally coupled to the inner face of the pipe. Thus, heat exchanges with the reaction products are improved, facilitating solidification of the carbon. According to one embodiment, the plurality of fins is arranged in the cooling chamber of the pipe.

According to one embodiment, the pipe may be without fins and comprise a smooth inner face.

According to one embodiment, the production and delivery unit comprises a fluid circulation device that is configured to at least partly cool the pipe. Thus, cooling of the reaction products is ensured through convective and conductive exchange with at least one inner face of the pipe which is cooled by the circulation device as the flow of reaction products flows to a separation and filtration device. The separation of the dihydrogen from the other reaction products is improved by this cooling. When the pipe additionally comprises the fins, separation is much more effective. In this context, it is understood that the inner face of the other portion of the pipe defining the cooling chamber is cooled by the fluid circulation device.

According to one embodiment, the production and delivery unit comprises a separation and filtration device in order to purify the dihydrogen produced by the plasmalysis with respect to the other reaction products. Thus, the dihydrogen is pure enough to be used in a fuel cell or a combustion engine, for example. The solid carbon may be recovered for industrial purposes.

According to one embodiment, the production and delivery unit comprises a return line that is configured to inject at least some of the plasmalysis reaction products into the resonant microwave radiation cavity. Thus, any leftover gaseous hydrocarbons are recycled and the amount thereof is reduced.

According to one embodiment, the reaction products mainly comprise gaseous dihydrogen and solid carbon, and possibly leftover gaseous hydrocarbons, such as methane.

According to one embodiment, the production and delivery unit comprises a compression device for transferring purified dihydrogen to the storage device. Thus, it is possible to meet the consumer's demand for dihydrogen under all circumstances.

According to one embodiment, the production and delivery unit comprises an electricity generator for generating electricity from the dihydrogen produced by the production and delivery unit and a battery for storing the electricity produced by the electricity generator with a view to supplying the production and delivery unit with electricity. This allows dihydrogen generation to be possible even if the electrical network is absent or unavailable. Coupled with the storage tank to supply dihydrogen, this makes it possible to have an autonomous unit for the production and delivery of dihydrogen in a carbon-free manner. The storage tank is changed or refilled by a vehicle as required. As this is being delivered, the solid carbon produced may be recovered by the same vehicle with a view to being recycled for various industrial uses.

According to one embodiment, the electricity generator is a fuel cell and/or an internal combustion engine associated with a generator.

According to one aspect of the invention, the production and delivery unit comprises a device for recovering the solid carbon generated by the plasmalysis.

Another subject of the invention is a system for the delivery of dihydrogen, in particular in a carbon-free manner, comprising a production and delivery unit that has at least one of the features described above and a dihydrogen consumer, the delivery device being configured to supply a tank of the consumer.

According to one embodiment, the dihydrogen consumer is a transport means, in particular a car.

Lastly, another subject of the invention is a method for operating a production and delivery unit that has at least one of the features described above, during which the microwave radiation generator is configured to deliver microwave radiation at a power of between 1 kW and 100 kW and a frequency of between 850 MHz and 6 GHz, preferentially equal to 896 MHz, 915 MHz, 922 MHz, 2.45 GHz or 5.8 GHz.

According to one optional aspect of this method, a step is provided in which the gaseous hydrocarbon is mixed beforehand with an auxiliary gas selected from among dihydrogen, dinitrogen or argon, before it is injected into the resonant cavity.

Other features and advantages of the invention will appear both from the description which follows and from several exemplary embodiments, which are given for illustrative purposes and without limitation with reference to the appended schematic drawings, in which:

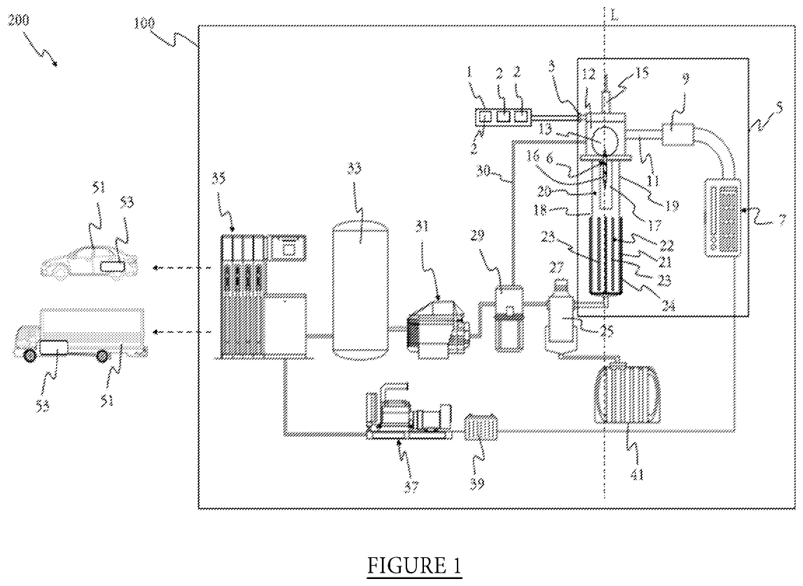

FIG. 1 schematically shows a unit for the production and delivery of dihydrogen in a carbon-free manner using a plasma generated by microwave radiation according to the invention.

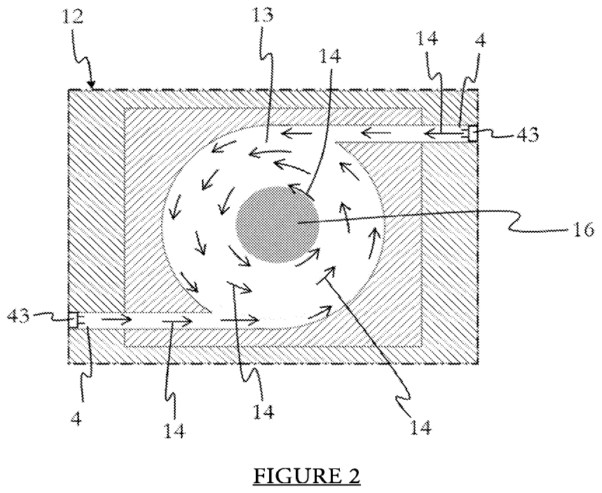

FIG. 2 schematically shows a microwave radiation cavity of the production and delivery unit of FIG. 1, viewed in a plane perpendicular to the longitudinal axis of the plasma.

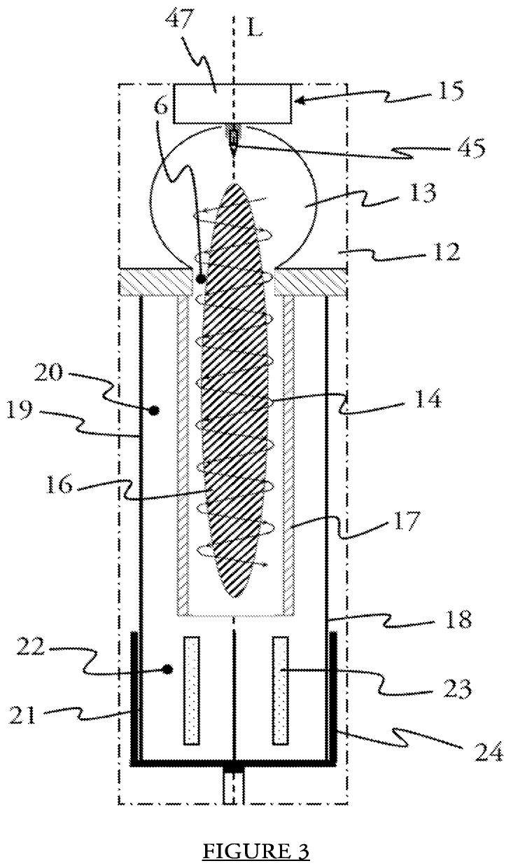

FIG. 3 is a detail view of the microwave radiation cavity of FIG. 2 with a nozzle tube and a pipe of the production and delivery unit of FIG. 1, viewed in a plane comprising the longitudinal axis of the plasma.

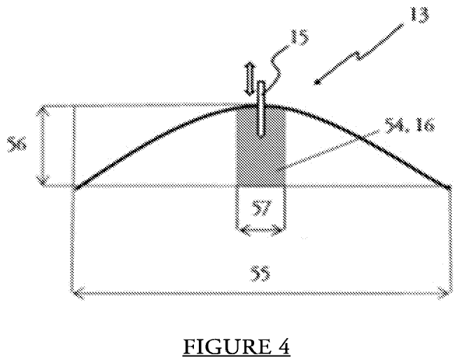

FIG. 4 is a schematic view illustrating dimensions of the resonant microwave radiation cavity of the plasmalysis reactor.

It should first of all be noted that while the figures set out the invention in detail for its implementation, they may of course be used to better define the invention where appropriate. It should also be noted that, in all of the figures, similar elements and/or elements fulfilling the same function are indicated by the same numbering.

FIG. 1 illustrates a unit 100 for the production and delivery of dihydrogen, in particular in a carbon-free manner, for a dihydrogen consumer 51, comprising at least one gaseous hydrocarbon supply device 1, at least one microwave plasma plasmalysis reactor 5 which is configured to generate plasmalysis of the gaseous hydrocarbon supplied by the supply device 1 and which produces at least dihydrogen, the production and delivery unit 100 comprising at least one storage device 33 for the produced dihydrogen and at least one device 35 for delivering to the consumer 51 the dihydrogen stored in the storage device 33.

Plasmalysis is a method that makes it possible to decompose the gaseous hydrocarbon into solid carbon C₍ₛ₎ and dihydrogen gas H2_{(g)} by virtue of a plasma generated by microwave radiation. The gaseous hydrocarbon may be methane CH₄, propane C₃H₈, butane C₄H₁₀ and its isomers, and/or natural gas or biomethane. Natural gas may predominantly comprise methane CH₄ and, to a lesser extent, propane C₃H₈, and/or butane C₄H₁₀ and its isomers. When the gaseous hydrocarbon is methane, the plasmalysis reaction is written as:

$$C {H}_{4} {\to }^{P l a s m a} 2 {H}_{2 ( g )} + {C}_{( s )} \qquad [ Math ]$$

Therefore, it can be seen that the plasmalysis method allows dihydrogen to be generated in a completely carbon-free process, that is without the emission of carbon dioxide.

In other words, gaseous dihydrogen and solid carbon are products of the plasmalysis.

The gaseous hydrocarbon required for the plasmalysis reaction that takes place in the plasmalysis reactor 5 is supplied by the supply device 1. The supply device 1 comprises at least one storage tank 2 which may be refilled, for example, by tanker trucks and/or be replaced when it is empty.

In one embodiment not shown, the gaseous hydrocarbon supply device is a hydrocarbon gas distribution network. The distribution network allows the gaseous hydrocarbon to be transported from the gas terminals. The distribution network is thus, for example, a gas distribution network for industrial or household use.

With reference to FIGS. 1 to 4, the plasmalysis reactor 5 comprises at least one microwave radiation cavity 13 formed in a metal block 12. The gaseous hydrocarbon from the supply device 1 is injected into the microwave radiation cavity 13, and the microwave radiation is also guided into the microwave radiation cavity 13. The microwave radiation cavity 13 is configured to at least partially hold the plasma 16. Thus, the resonant microwave radiation cavity 13 allows very effective coupling of the microwave radiation with the plasma 16.

As illustrated in FIGS. 3 and 4, the microwave radiation cavity 13 is coupled to a waveguide specific to the frequencies between 850 MHz and 6 GHz, preferentially equal to 896 MHz, 915 MHz, 922 MHz, 2.45 GHz or 5.8 GHz. It is resonant, that is to say that 100% of the microwave radiation is reflected across the microwave radiation cavity 13 by at least one wall of the block 12 that defines the microwave radiation cavity 13 when there is no plasma 16 present in the microwave radiation cavity 13.

As shown in FIG. 4, the dimensions of an active discharge zone 54 of the resonant microwave radiation cavity 13 are defined by the frequency used. The active discharge zone 54 is the zone where the plasma 16 forms. The width 55 of the resonant microwave radiation cavity 13 is defined by the frequency used and by the type of waveguide, the height 56 of the resonant microwave radiation cavity 13 is equal to half the width 55 of this resonant microwave radiation cavity 13 and the width 57 of the active discharge zone 54 is less than or equal to the height 56 of the resonant microwave radiation cavity 13. Because of the geometry of the resonant microwave cavity, the microwaves concentrate close to center of the cavity to form an electromagnetic field distribution with a power density high enough to ionize the gaseous hydrocarbon flow. The active discharge zone 54, also called the plasma zone for the plasma 16, is the zone where the interaction between the electromagnetic field and the ionized gaseous hydrocarbon flow is optimal. The plasma is ignited by inserting the ignition device 15 into the center of the active discharge zone 54.

The injection of the gaseous hydrocarbon into the microwave radiation cavity 13 is carried out by an injection device 3 of the plasmalysis reactor 5. More specifically, as illustrated in FIG. 2, the injection device 3 comprises at least one nozzle 43—two nozzles 43 in this instance—coupled to at least one inlet 4 of the microwave radiation cavity 13. The nozzle 43 allows a gaseous hydrocarbon flow from the supply device 1 to be created.

The inlet 4 is arranged tangentially to a direction of elongation of the plasma 16. The inlet 4 is also arranged tangentially to a wall that defines the microwave radiation cavity 13. This configuration then allows a vortex of the gaseous hydrocarbon flow 14 to be created in the microwave radiation cavity 13 as illustrated in FIG. 2 and FIG. 3. The vortex helps to stabilize the plasma 16.

A portion of the gaseous hydrocarbon flow 14 in the vortex that is coupled with the microwave radiation contributes to producing the plasma 16. This portion of the gaseous hydrocarbon flow 14 in the vortex producing the plasma will also undergo plasmalysis. It is understood in this context that the gas used to form the plasma and the gas that undergoes plasmalysis are the same. In other words, a single gas from a single source makes it possible to produce the plasma and produce dihydrogen and solid carbon. Stated otherwise, the gaseous hydrocarbon serves both as a plasmagene gas and as a plasmalysis reactant.

With reference to FIG. 1, the plasmalysis reactor 5 comprises a microwave radiation generator 7 which allows a plasma to be created in the microwave radiation cavity 13. The microwave radiation generator 7 may be a magnetron microwave radiation generator or a semiconductor microwave generator, which is also called a solid-state microwave generator.

In one embodiment not shown, the microwave radiation generator 7 is cooled by a water and/or air cooling device. This allows the microwave radiation generator 7 to be kept at an optimum operating temperature.

The microwave radiation generator 7 is configured to generate microwave radiation at a power of between 1 kW and 100 kW and a frequency of between 850 MHz and 6 GHz, preferentially equal to 896 MHz, 915 MHz, 922 MHz, 2.45 GHz or 5.8 GHz.

As shown in FIG. 1, the microwave radiation is directed toward the microwave radiation cavity 13 by a transmission guide 11 that is coupled to the microwave radiation generator 7. The transmission guide 11 is a rectangular or cylindrical waveguide or a coaxial cable.

A microwave radiation isolator 9 is arranged between the microwave radiation generator 7 and the transmission guide 11, that is at the coupling between the microwave generator 7 and the transmission guide 11. The isolator 9 prevents microwave radiation not absorbed by the plasma 16 from returning to the microwave radiation generator 7 via reflection in the transmission guide 11.

With reference to FIGS. 1, 3 and 4, the plasmalysis reactor 5 comprises a device 15 for igniting the plasma 16. The ignition device 15 is an electromechanical mechanism including a metal tip 45 and an actuator 47 which moves the metal tip 45 between a position outside the microwave radiation cavity and a position inside the microwave radiation cavity. The metal tip 45 is therefore retractable.

Thus, to ignite the plasma, the microwave radiation generated by the microwave radiation generator 7 is transmitted to the microwave radiation cavity 13 into which the gaseous hydrocarbon is injected tangentially to the walls of the microwave radiation cavity 13 to form a vortex from the gaseous hydrocarbon flow. As soon as the required microwave radiation power is reached, the plasma is ignited by the ignition device 15, the metal tip 45 of which remains in the active discharge zone of the microwave radiation cavity 13 for less than a second. The gaseous hydrocarbon flow 14, which is itself used to produce the plasma 16, thus undergoes the plasmalysis reaction. After the plasma ignition phase, the plasma is maintained and stabilized by the microwave flux and the gaseous hydrocarbon flow in the vortex.

The pressure in the microwave radiation cavity 13 is greater than or equal to atmospheric pressure. More generally, the pressure within at least part of the production and delivery unit 100 is greater than or equal to atmospheric pressure.

With reference to FIG. 1 and FIG. 3, an outlet 6 of the microwave radiation cavity 13 is extended by a nozzle tube 17 composed at least partly of ceramic and/or metal. The nozzle tube 17 is used to contain the plasma. The nozzle tube 17 is also used to ensure that the plasmalysis reaction continues by protecting the reaction products, in particular the plasmalysis products, from rapid cooling at the outlet 6 of microwave radiation cavity 13. In other words, the nozzle tube 17 therefore allows the temperature of the reaction products, in particular the plasmalysis products, to reduce gradually at the outlet 6 of the microwave radiation cavity 13.

The plasma 16, once created, extends both inside the microwave radiation cavity 13 and into the nozzle tube 17 along a longitudinal axis L. Thus, the nozzle tube extends from the outlet 6 of the microwave radiation cavity 13 in a direction away from the microwave radiation cavity along the longitudinal axis L.

With reference to FIG. 1, the plasmalysis reactor 5 comprises a pipe 18 which extends from the vicinity of the outlet 6 of the microwave radiation cavity 13 in a direction opposite the microwave radiation cavity 13 along the longitudinal axis L. The dimension of the pipe 18 measured along the longitudinal axis L is greater than the dimension of the nozzle tube 17 measured along the longitudinal axis L. The pipe completely surrounds the nozzle tube 17.

A first portion 19 of the pipe 18 takes the shape of a cylinder that is concentric relative to the nozzle tube 17. Thus, a chamber for thermally isolating the plasma 16 is defined between an outer face of the nozzle tube 17 and an inner face of the first portion 19 of the pipe 18. The chamber 20 allows the plasma 16 to be thermally isolated in order to reduce, or even eliminate, temperature inhomogeneities within the plasma 16, in particular on its periphery.

The pipe 18 comprises a second portion 21 which extends the first portion 19 of the pipe along an axis parallel to the longitudinal axis L of the plasma 16. The second portion 21 of the pipe 18 defines a cooling chamber 22. Thus, the cooling chamber allows the reaction products to be cooled. Solidification of the carbon is thus improved thereby. The reaction products group together methane that did not decompose during the plasmalysis and the plasmalysis products, that is dihydrogen gas and solid carbon.

In the embodiment of the invention in FIG. 1, the second portion 21 of the pipe 18 includes, on its inner face, a plurality of fins 23 which extend radially from the inner face of the second portion 21 of the pipe 18 in the direction of the nozzle tube 17 and are thermally coupled to the inner face of the second portion of the pipe 18. Thus, heat exchanges with the reaction products that come into contact with the fins 23 are improved, facilitating solidification of the carbon produced by plasmalysis.

A fluid circulation device 24 is arranged against an outer wall of the second portion 21 of the pipe 18 so as to at least partly cool the second portion 21 of the pipe 18. Thus, the cooling of the reaction products in the cooling chamber 22 is ensured through convective and conductive exchange with at least part of the inner face of the second portion 21 of the pipe 18 which is cooled by the fluid circulation device 27. The separation of the dihydrogen from the other reaction products is improved by this cooling. When the pipe 18 further comprises the fins 23 which are then themselves also cooled by thermal conduction, the separation is even more efficient. This is very useful in particular when the flow of reaction products flows to a separation and filtering device 25, 29 with which the production and delivery unit 100 is equipped.

The separation and filtration device 25, 29 with which the production and delivery unit 100 is equipped comprises a vortex separator element 25. The separator element 25 is configured to suck in the flow of cooled reaction products from the cooling chamber 22. The cooled solid carbon is deposited either on a bottom of the separator element 25 or on an inner surface of a wall of the separator element 25.

Other solid particles are present in the flow of cooled reaction products and also are deposited at the same locations as the solid carbon.

The solid carbon thus recovered is stored in a recovery device 41 and may be taken care of by the same vehicle that changes or refills the storage tanks 2. The solid carbon may then be recycled for various industrial uses.

Next, the flow of reaction products free of solid particles is filtered by a filtration system 29 of the separation and filtration device 25, 29. The dihydrogen obtained after filtration then has a level of purity that allows it to be used either in a fuel cell or in an internal combustion engine. The other reaction products after filtration may be recycled by reinjecting them back into the microwave radiation cavity 13 via a return pipe 30.

The production and delivery unit 100 comprises a compression device 31 for transferring the purified dihydrogen to a storage device 33 such as a tank or a cylinder. The dihydrogen is then stored at a pressure of up to about 900 bars. Thus, it is possible to meet the consumer's demand for dihydrogen under all circumstances.

The delivery system 35 makes it possible to fill the dihydrogen tanks of at least one consumer 51, such as land transport means, in particular cars and/or trucks, sea transport means, such as a ship, or air transport means, such as an airplane. The delivery system 35 draws the dihydrogen from the storage device 33.

The production and delivery unit 100 further comprises an electricity generator 37 for generating electricity from the dihydrogen produced and a battery 39 for storing the electricity produced by the electricity generator 37.

The battery 39 thus allows the production and delivery unit 100 be supplied with electricity even if the electrical network is absent or unavailable. In this context, it is understood that the production and delivery unit as illustrated in FIG. 1 may be autonomous.

Of course, the invention is not limited to the examples that have just been described, and numerous modifications can be made to these examples without departing from the scope of the invention.

The invention as has just been described clearly achieves the aim that it set for itself, and makes it possible to provide a unit for the production and delivery of dihydrogen in a carbon-free manner that is, in particular, straightforward to implement, economically viable, does not emit greenhouse gases and is even autonomous if required by environmental constraints.

1. A dihydrogen production and delivery unit configured for a dihydrogen consumer, the unit comprising:
a gaseous hydrocarbon supply device;
a microwave plasma plasmalysis reactor configured to generate, at a pressure equal to atmospheric pressure +/−15%, plasmalysis of the gaseous hydrocarbon supplied by the supply device, the microwave plasma plasmalysis reactor producing at least H₂ and comprising a resonant microwave radiation cavity configured to hold a plasma;
a storage device suitable for the H₂produced; and
a delivery device configured for delivering to the consumer H₂ stored in the storage device.

2. The production and delivery unit of claim 1, wherein the gaseous hydrocarbon is methane and/or natural gas.

3. The production and delivery unit of claim 1, wherein the gaseous hydrocarbon supply device is a gaseous hydrocarbon transmission network and/or at least one storage tank constituting the production and delivery unit.

4. The production and delivery unit of claim 1, wherein the microwave plasma plasmalysis reactor comprises
a microwave radiation generator,
a transmission guide configured to guide microwave radiation from the microwave radiation generator to the microwave radiation cavity of the microwave plasma plasmalysis reactor, and
a microwave radiation isolator configured to prevent the microwave radiation not absorbed by the plasma from returning to the microwave radiation generator.

5. The production and delivery unit of claim 1, wherein the microwave plasma plasmalysis reactor comprises a plasma ignition device comprising a retractable metal tip that is configured to be inserted into or retracted in the microwave radiation cavity using an actuator.

6. The production and delivery unit of claim 1, wherein the microwave plasma plasmalysis reactor comprises a gas injection device comprising a nozzle configured to generate a gas flow of gaseous hydrocarbon from the supply system and is arranged in the microwave radiation cavity so as to form a vortex from the flow of gaseous hydrocarbon in the microwave radiation cavity.

7. The production and delivery unit of claim 1, wherein the microwave plasma plasmalysis reactor comprises a nozzle tube configured to contain the plasma and ensure a gradual lowering of temperature of products from plasmalysis at an outlet of the microwave radiation cavity.

8. The production and delivery unit of claim 7, wherein the microwave plasma plasmalysis reactor comprises a pipe arranged around the nozzle tube such that at least a portion of the pipe defines a chamber suitable for thermally isolating the plasma.

9. The production and delivery unit of claim 8, wherein at least a other portion of the pipe further defines a chamber for cooling the H₂ and solid carbon produced by plasmalysis.

10. The production and delivery unit of claim 1, further comprising:
a separation and filtration device so as to purify the H₂ produced by plasmalysis.

11. The production and delivery unit of claim 1, further comprising:
an electricity generator configured for generating electricity from the H₂ produced by the production and delivery unit and a battery configured for storing electricity produced by the electricity generator and configured for supplying the production and delivery unit with electricity.

12. The production and delivery unit of claim 1, further comprising:
a recovery device configured for recovering solid carbon generated by the plasmalysis.

13. A dihydrogen delivery system, comprising:
the production and delivery unit of claim 1; and
a dihydrogen consumer,
wherein the delivery device is configured to supply a tank of the consumer.

14. A method for operating the dihydrogen production and delivery unit of claim 4, the method comprising:
delivering, with the microwave radiation, microwave radiation at a power in a range of from 1 to 100 kW and a frequency in a range of from 850 MHz to 6 GHz.

15. The method of claim 14, wherein the gaseous hydrocarbon is previously mixed with an auxiliary gas comprising H₂, N₂, and/or Ar, before the gaseous hydrocarbon is injected into the microwave radiation cavity, which is a resonant cavity.

16. The production and delivery unit of claim 1, wherein the gaseous hydrocarbon comprises methane.

17. The production and delivery unit of claim 1, wherein the gaseous hydrocarbon comprises natural gas.
